(19) United States
(12) Patent Application Publication
(10) Pub. No.: US 2010/0190072 A1
(43) Pub. Date: Jul. 29, 2010

(54) OPERATION METHOD FOR FUEL CELL

(75) Inventor: Xie Gang, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Aichi-ken (JP)

(21) Appl. No.: 12/676,148

(22) PCT Filed: Aug. 27, 2008
(86) PCT No.: PCT/JP2008/065304

§ 371 Date: Mar. 3, 2010

(30) Foreign Application Priority Data
Sep. 3, 2007 (JP) 2007-228262

(51) Int. Cl. H01M 8/04

(52) U.S. Cl. 429/429

(57) ABSTRACT

The operation method for a fuel cell which is advantageous in lifespan of the fuel cell is provided in which a sudden rise of an electrode potential at a cathode of the fuel cell can be suppressed and deterioration of the cathode is restrained. A concentration level reduction controlling is conducted in which at the start-up operation, the concentration level of oxygen introduced into the cathode of the fuel cell is lowered than the concentration level of oxygen introduced into the cathode under the normal operation so that the rise of electrode potential at the cathode can be suppressed.

### TECHNICAL FIELD

This invention relates to an operation method, in which a normal operation is performed after a start-up operation for a fuel cell.

### BACKGROUND OF THE TECHNOLOGY

A fuel cell is a battery that takes out an electric energy by electro-chemical electric generation reaction. The fuel cell includes a cathode to which a cathode fluid including oxygen is supplied, an anode to which an anode fluid including hydrogen is supplied and an electrolyte film provided between and supported by the cathode and the anode. The reactions of electric generation at the anode and the cathode of the fuel cell are shown below as formulae (1) and (2):

Anode: H₂→2H⁺+2e⁻(oxidization reaction) (1)

Cathode: 1/2O₂+2H⁺+2e⁻→H₂O(reduction reaction) (2)

According to the electric generation above, the electron (e⁻) generated at the anode by the electro-chemical oxidization reaction of hydrogen moves into the cathode and at the cathode, the reduction reaction is carried out. Such electric generation reaction progresses during the electric generation.

As a method for starting the operation of the fuel cell, a technology is disclosed in a patent document 1, wherein the document discloses a fuel cell, an electricity consuming means (electric discharge resistance) and an exterior load provided outside of the fuel cell and by using these, up to the stage that the fuel cell is connected to the exterior load, the air is introduced into the cathode with the introduction of reform gas into the anode of the fuel cell and the introduction amount of either one of the air and reformed gas is gradually increased and the generated electricity is discharged and consumed by the electricity consuming means (electric discharge resistance).

After the start-up operation ends, the fuel cell and the exterior load are electrically connected to operate the exterior load. According to the technology of the patent document 1, the electricity generated at the fuel cell is discharged and consumed by the electricity consuming means (electric discharge resistance). Further, another technology is known as a start-up method for operation of the fuel cell, in which by providing an auxiliary resistance load (electric resistance value being fixed) in addition to the main resistance load upon starting of operation of the fuel cell, the fuel cell and the auxiliary resistance load are electrically connected by switching ON, the cell voltage upon starting operation is reduced by the auxiliary resistance load. (Patent document 2).

Patent document 1: Japanese patent application publication 1993-251101 A

Patent document 2: Japanese patent application publication 2005-515603 A

### DISCLOSURE OF INVENTION

### Problems to be Solved by the Invention

According to the patent publications 1 and 2, in the start-up operation stage which is the time before the electric connection stage of the fuel cell with an exterior load to operate the exterior load by the electric energy of the fuel cell, the fuel cell has been electrically connected to the electricity consuming means or the auxiliary resistance load and the electric energy generated at the fuel cell is discharged and consumed by the electricity consuming means or the auxiliary resistance load.

According to the patent publications 1 and 2, not only the normal operation stage in which the exterior load is operated, but also the start-up operation stage before the normal operation starts, the fuel cell has already progressed electric generation reaction described above (1) and (2) and the electron generated in the anode has moved into the cathode. According to these technologies, after the electricity is generated, the open circuit voltage state in the fuel cell over a long period of time can be avoided.

According to the technologies described in the publications, the open circuit voltage state in the fuel cell over a long period of time can be avoided and a possible deterioration of the cathode can be restrained. However, a rising speed of cathode electrode potential due to the positive introduction of the air (oxygen) is not controlled, and therefore, the rising speed of cathode electrode potential becomes very fast in the start-up operation, which may accelerate a deterioration of components of cathode electrode. Further, since the fuel cell and the electricity consuming means and the auxiliary resistance load are electrically connected and the electric energy generated by the fuel cell is discharged and consumed by the electricity consuming means and the auxiliary resistance load even at the start-up operation, the electric generation reaction is progressing at both anode and cathode of the fuel cell. Accordingly, not only the fuel is consumed at the anode, but also the heat generation increases at the fuel cell. If the fuel cell is used for a long period of time, components of the fuel cell may be deteriorated because of such heat generation.

Further, as stated above, since the electric generation reaction has been progressed at both the anode and the cathode even in the start-up operation, oxidization of hydrogen at the anode is also progressing. If the hydrogen is not sufficiently supplied to the anode, hydrogen deficiency may occur at the anode side. Under such hydrogen deficiency condition, a component of anode electrode may be electro-chemically oxidized instead of hydrogen. In this case, the anode component (such as, carbon system conductive material, such as carbon black, and catalyst) may be deteriorated due to the oxidization.

Need thus exists for a method for operating a fuel cell which can restrain a sudden or abrupt rise of cathode electrode potential of the fuel cell at the start-up operation and at the same time can restrain deterioration of cathode and in addition, restrain deterioration of anode. It is an objective to provide a method for operating a fuel cell having advantages in providing a long life fuel cell.

### Means for Solving the Problem

(1) According to a first aspect of the present invention, an operation method for a fuel cell under a normal operation after a start-up operation for activating the fuel cell, by using the fuel cell having a cathode to which a cathode fluid including oxygen is supplied, an anode to which an anode fluid including hydrogen is supplied and an electrolyte film provided between and supported by the cathode and the anode, characterized in that by setting the cathode and the anode of the fuel cell to be in open circuit voltage state under the start-up operation, a concentration level reduction controlling to restrain a rise of electrode potential at the cathode is conducted by lowering an oxygen concentration level at a cathode side of the fuel cell to a level lower than an oxygen concentration level under the normal operation.

It is noted here that the cathode equilibrium electrode potential basically depends on the concentration level of an active substance such as oxygen under open circuit voltage (OCV) state and is subject to the Nernst equation in electro-chemical technological field. Generally, the electrode potential at the cathode under the OCV state is higher than the electrode potential at the cathode under normal operation of the fuel cell.

According to the aspect 1 of the present invention above, the fuel cell is set to be in open circuit voltage state at the start-up operation and at the same time the concentration level is controlled so that the concentration level of oxygen introduced into the cathode is lowered than the concentration level of the oxygen introduced into the cathode under normal operation. Thus the electrode potential at the cathode is kept to a lower level and accordingly, a sudden rise of the electrode potential at the cathode at the start-up operation can be restrained. A deterioration of components forming the cathode depends not only on the absolute value of the electrode potential at the cathode, but also on the rising speed of the electrode potential at the cathode. Accordingly, if a plenty of oxygen (air) necessary for electric generation operation are supplied to the cathode having a low oxygen concentration level, the electrode potential at the cathode suddenly rises from a lower level. This sudden rise of the electrode potential at the cathode accelerates deterioration of the cathode components. It is noted here that the oxygen is a cathode active substance used at the electric generation at the cathode and the hydrogen is an anode active substance used at the electric generation at the anode.

Throughout the specification of the present application, the “normal operation” means an operation necessary for operating an exterior load by electric energy of the fuel cell. The normal operation does not include the start-up operation. The upper limit of the normal operation is the rated operation and the operation allows some fluctuations of electric energy which may be consumed in response to the operation amount of the exterior load. It is noted here that the “rated” means the maximum output in use under which the manufacturer guarantees the continuous operation under certain conditions. This value is generally clearly indicated on a rating plate or in a brochure. Accordingly, the rated operation is an operation in which the maximum output of the electric generation is outputted under a continuous normal operation. The normal operation in the specification may be replaced with the rated operation.

The start-up operation means a starting operation before the normal operation begins. According to this aspect, the start-up operation is performed under the open circuit voltage state where the cathode and the anode of the fuel cell are not electrically connected. Since the cathode and the anode are not connected electrically, the movement of electron (e⁻) at the anode and the cathode of the fuel cell is suppressed. Basically, the progresses of the electric generation reactions above formulae (1) and (2) are restrained. This can restrain the heat generation of the fuel cell in start-up operation. Thus the deterioration of materials composing the fuel cell derived from the generated heat can be restrained. Further, as mentioned above, since the progressing of electric generation at the cathode and the anode of the fuel cell is restrained, an excess consumption of hydrogen at the anode can be restrained at the start-up operation. This can restrain the deterioration derived from the heat generation.

Further, according to this aspect, the fuel cell is kept to the open circuit voltage state at the start-up operation, and accordingly, the electric generation reaction at both anode and cathode sides of the fuel cell can be restrained and any possible hydrogen deficiency at the anode under the start-up operation can be avoided. At the anode side, if the hydrogen is insufficient, instead of hydrogen, anode composing material may be electro-chemically oxidized. This may be not preferable, since the anode composing materials (such as carbon system conductive material, catalyst) may be deteriorated by oxidization.

If the electric generation reaction is in progress under the start-up operation at both anode and cathode sides, the hydrogen oxidization is also in progress at the anode side and unless sufficient hydrogen is supplied to the anode side, hydrogen deficiency may occur at the anode side. In such case, instead of hydrogen, anode composing materials (carbon system conductive material, such as, carbon black etc. and catalyst) may be electro-chemically deteriorated by oxidization. It should be noted that according to this aspect of the invention, the anode and the cathode of the fuel cell are not electrically connected at the start-up operation and the fuel cell is kept in open circuit voltage state not to generate any electric generation reaction. Therefore, the hydrogen can be introduced into the anode side or inactive nitrogen can be introduced into the anode side.

(2) According to another aspect 2 of the invention, an operation method for a fuel cell having a cathode to which a cathode fluid including oxygen is supplied, an anode to which an anode fluid including hydrogen and an electrolyte film provided between and supported by the cathode and the anode, under a normal operation after a start-up operation for activating the fuel cell, wherein a concentration level reduction controlling is conducted to restrain a rise of electrode potential at the cathode by lowering the number of mole of oxygen introduced into the cathode of the fuel cell per unit time under the start-up operation than the number of mole of oxygen introduced into the cathode per unit time under the normal operation.

According to the aspect 2 of the invention, the oxygen concentration level is controlled so that the concentration level of oxygen introduced into the cathode (the number of mole of oxygen introduced into the cathode per unit time) is lowered in the start-up operation, than the concentration level of the oxygen introduced into the cathode (the number of mole of oxygen introduced into the cathode per unit time) under normal operation. Thus the electrode potential at the cathode is kept to a lower level at the start-up operation and accordingly, a sudden rise of the electrode potential at the cathode at the start-up operation can be restrained. A deterioration of components forming the cathode depends not only on the absolute value of the electrode potential at the cathode, but also on the rising speed of the electrode potential at the cathode. Accordingly, if a plenty of oxygen (air) necessary for electric generation operation are supplied to the cathode having a low oxygen concentration level, the electrode potential at the cathode suddenly rises from a lower level. This sudden rise of the electrode potential at the cathode accelerates deterioration of the cathode components.

It is preferable to keep the fuel cell to be in open circuit voltage state at the start-up operation. In such case, since the electric generation reaction at both anode and cathode of the fuel cell can be restrained and possible hydrogen deficiency at the anode under the start-up operation can be avoided. At the anode side, if the hydrogen is insufficient, instead of hydrogen, anode composing material may be electro-chemically deoxidized. This may be not preferable, since the anode composing materials (such as carbon system conductive material, catalyst) may be deteriorated by oxidization. According to the aspect of the invention, since the electric generation reaction is not generated in the stat-up operation, the hydrogen can be introduced into the anode or inactive nitrogen can be introduced into the anode.

(3) According to a third aspect 3 of the invention, an operation method for a fuel in addition to the above aspects 1 and 2 is characterized in that the method includes concentration level reduction controlling process under the anode fluid including hydrogen being introduced into the anode of the fuel cell, or under the anode fluid including hydrogen being in progress of introduction into the anode of the fuel cell. In this case, the start-up operation is carried out under the anode fluid including hydrogen being in existing in the anode of the fuel cell. Accordingly, the hydrogen (anode active substance) deficiency at the anode of the fuel cell is properly restrained not only during the start-up operation, but also at the normal operation immediately after the start-up operation. Thus, the oxidization reaction of the anode composing materials can be restrained. As an anode composing material, carbon system conductive material (minute carbon material such as carbon black) used for catalyst carrier is exampled.

(4) An operation method for a fuel cell according to a fourth aspect of the present invention includes a method for normal operation of a fuel cell after a start-up operation thereof by using a fuel cell having a cathode to which a cathode fluid including oxygen is supplied, an anode to which an anode fluid including hydrogen is supplied and an electrolyte film provided between and supported by the cathode and the anode, characterized in that the method includes a concentration level reduction controlling to restrain a rise of electrode potential at the cathode by lowering an oxygen concentration level at the cathode side of the fuel cell at the start-up operation from the oxygen concentration level under the normal operation of the fuel cell, under a variable electric discharge resistance which can variably change the electric resistance value being connected between the anode and the cathode of the fuel cell. It is noted here that the oxygen concentration level can be lowered by decreasing the number of mole of oxygen introduced per unit time.

According to this aspect of the invention, in a start-up operation, oxygen (cathode active substance) concentration level is controlled to be lowered and the number of mole of the oxygen introduced into the cathode of the fuel cell per unit time is set to be lesser than the number of mole of the oxygen introduced into the cathode per unit time at the normal operation. In other words, in the start-up operation, oxygen concentration level is controlled to be lowered and the concentration level of the oxygen introduced into the cathode of the fuel cell is set to be lesser than the concentration level of the oxygen introduced into the cathode at the normal operation. Thus the electrode potential at the cathode is kept to a lower level, and accordingly, a sudden rise of the electrode potential at the cathode at the start-up operation can be restrained. The deterioration of the cathode composing materials (such as carbon system electric conductive material or catalyst) can be restrained.

According to this aspect of the invention, the variable electric discharge resistance can variably change the electric resistance value. In the start-up operation, it is preferable to carry out a resistance increase controlling in which the electric resistance value of the variable discharge resistance is gradually increased. When the electric resistance value of the variable electric discharge resistance located between the anode and the cathode is low, the current flowing through the variable electric discharge resistance is high and the cell voltage (cell voltage value=cathode electrode potential−electrode potential) is low. When the electric resistance value of the variable discharge resistance is high, the current flowing through the variable electric discharge resistance is low and the cell voltage is high. During the resistance increase controlling which is carried out in the start-up operation, the electric resistance value of the variable electric discharge resistance is gradually increased with time. The cell voltage is low at the initial stage of the start-up operation, but the voltage increases gradually with time. In other words, the cathode electrode potential is low at the initial stage of the start-up operation, but the cathode electrode potential increases gradually with time, that is, as the fuel cell operation approaches from the start-up to normal operation. Thus the transit from the start-up to normal operation of the system is carried out promptly.

According to this aspect of the invention, since the electric resistance value of the variable electric discharge resistance is low at the initial stage of the start-up operation, the current flowing through the variable electric discharge resistance is high and accordingly the cathode electrode potential (substantially the cell voltage) becomes low. It is preferable to increase the electric resistance value of the variable electric discharge resistance as the start-up operation approaches the end stage. In such case, the current flowing through the variable electric discharge resistance becomes low and the cathode electrode potential (cell voltage) gradually increases. Since the sudden increase of the cathode electrode potential is restrained at the start-up operation, the deterioration of the cathode is restrained and yet the system can smoothly moves from the start-up operation to the normal operation.

### THE EFFECTS OF THE INVENTION

According to the invention, under the start-up operation, the concentration level reduction controlling with respect to oxygen level can be achieved to reduce the concentration level of oxygen introduced into the cathode of the fuel cell to a level smaller than the concentration level of oxygen introduced into the cathode under the normal operation. This can restrain the cathode electrode potential to be relatively small to restrain the sudden rise of the cathode electrode potential. As the result, according to the invention, the deterioration of the fuel cell can be restrained. Particularly, the deterioration of cathode composing materials (carbon system conductive material, catalyst) can be restrained.

### BRIEF EXPLANATION OF ATTACHED DRAWINGS

FIG. 1 indicates a fuel cell system according to an embodiment 1 of the invention;

FIG. 2A indicates a graph showing a relationship between the time and the air introduced flow rate at the start-up operation according to the embodiment 1 of the invention;

FIG. 2B indicates a graph showing a relationship between the time and the cathode electrode potential at the start-up operation according to the embodiment 1 of the invention;

FIG. 3 indicates a fuel cell system according to an embodiment 5 of the invention;

FIG. 4 indicates a graph showing the measurement result of the cathode rising speed state according to each example; and

FIG. 5 indicates a process for manufacturing a film electrode assembly.

### EXPLANATION OF NUMERALS

Numeral 1 designates a stack, numeral 10 designates a cathode, numeral 11 designates an anode, numeral 13 designates an electrolyte film, numeral 2 designates a cathode gas passage, numeral 20 designates a cathode gas valve, numeral 22 designates a feeder source, numeral 4 designates a cathode off gas passage, numeral 40 designates a cathode off gas valve, numeral 51 designates a reformer, numeral 5 designates an anode off gas valve, numeral 50 designates an anode gas valve, numeral 6 designates an anode off gas passage, numeral 60 designates an anode off gas valve, numeral 15 designates a conductive wire, numeral 16 designates a main switching element, numeral 17 designates an exterior load, numeral 17 designates a switching element and numeral 19 designates a variable electric discharge resistance.

### THE BEST MODE EMBODIMENTS OF THE INVENTION

### Embodiment 1

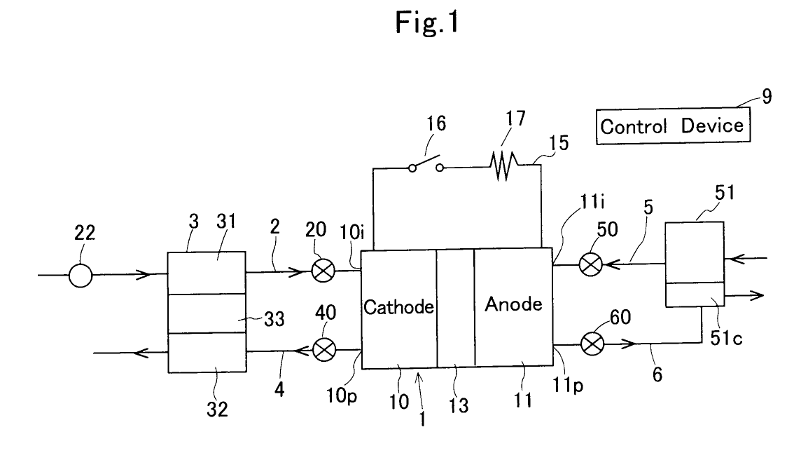

FIG. 1 indicates a schematic view of the fuel cell system according to the embodiment 1. The stack 1 is formed by stacking a plurality of cells. Each cell of the fuel cell includes a film electrode assembly. The film electrode assembly includes a cathode 10 to which the air including oxygen (cathode active substance) is supplied as a cathode gas (cathode fluid), an anode 11 to which the hydrogen gas (anode fluid) including hydrogen (anode active substance) is supplied as an anode gas and an electrolyte film 13 provided between and supported by the cathode 10 and the anode 11. In FIG. 1, the film electrode assembly is schematically illustrated.

A cathode gas passage 2 is connected to an inlet 10i of the stack 1. The cathode gas passage 2 is provided with a humidifier 3 for humidifying the cathode gas introduced into the cathode 10, a cathode gas valve 20 for variably changing the opening degree of the cathode gas passage 2 and a feeder source 22 (such as fan, blower or compressor) for feeding the cathode gas into the cathode 10.

The humidifier 3 includes a passage shaped humidifying portion 31, a passage shaped humidity absorbing portion 32 and a water reserving member 33 dividing the humidifying portion 31 and the humidity absorbing portion 32. It is noted here that any type of humidifier other than the one 3 illustrated here may be employed or the humidifier may not be used according to circumstances.

As shown in FIG. 1, a cathode off gas passage 4 is connected to an outlet 10p of the cathode 10 of the stack 1. The cathode off gas passage 4 is provided with the humidity absorbing portion 32 of the humidifier 3 for concentrating a warm cathode off gas (air off gas) discharged from the cathode 10 of the stack 1 after the electric generation reaction and removing the water therefrom and a cathode off gas valve 40 for opening and closing the cathode off gas passage 4.

As shown in FIG. 1, an anode gas passage 5 is connected to an inlet 11i of the anode 11 and the passage 5 is also connected to a reformer 51 which serves as an anode gas supply source. It is noted here that as an anode gas supply source, a hydrogen cylinder or tank may be used instead of using the reformer 51. The anode gas passage 5 is provided with an anode gas valve 50 for opening or closing the anode gas passage 5. An anode off gas passage 6 is connected to an outlet 11p of the anode 11 for guiding an anode off gas discharged from the anode 11 of the stack 1 to a combustion portion 51c of the reformer 51.

The anode off gas passage 6 is provided with an anode off gas valve 60 for opening or closing the anode off gas passage 6. The valves (cathode gas valve 20, anode gas valve 50, cathode off gas valve 40 and anode off gas valve 60) may be a type of changing the valve opening degree from 0 to 100% (ON-OFF) or a type of variably changing the valve opening degree consecutively or intermittently between 0 and 100%. Any type valve may be used as long as such valve has an opening and closing function.

As shown in FIG. 1, the anode 11 and the cathode 10 of the stack 1 are electrically connected with each other by a lead wire 15. The lead wire 15 is provided with a main switching element 16 and an exterior load 17. The exterior load 17 means a load operated by the electric energy generated by the stack 1. The main switching element 16 supplies electric energy of the stack 1 to the exterior load 17 or interrupts its supply to the exterior load 17. A control device 9 controls the functions of each valve 20, 40, 50 and 60, feeder source 22 and main switching element 16.

In order to operate the stack 1 of the fuel cell, first a start-up operation is carried out and after the start-up operation, the stack 1 of the fuel cell is changed to a normal operation (normal operation is carried out). The electric generation reactions at the anode 11 and the cathode 10 of the stack 1 are as follows:

Anode 11: H₂→2H⁺+2e⁻(oxidization reaction) (1)

Cathode 10: 1/2O₂+2H⁺+2e⁻→H₂O(reduction reaction) (2)

The electric generation above, the electron (e⁻) generated at the anode 11 by the electro-chemical oxidization reaction of hydrogen moves into the cathode 10 and at the cathode 10, the reduction reaction is progressed.

According to the embodiment of the invention, the start-up operation is carried out under the open circuit voltage state in which the cathode 10 and the anode 11 of the stack 1 are not electrically connected to the exterior load or an electric discharge resistance, in other words, under no load applied state. Thus, the start-up operation is carried out under the main switching element 16 being OFF state.

In the start-up operation, the anode gas valve 50 and the anode off valve 60 are opened to consecutively introduce hydrogen gas as an anode gas into the anode 11 of the stack 1. Further, the feeder source 22 is consecutively driven and at the same time the cathode gas valve 20 and the cathode off gas valve 40 are opened to consecutively introduce air as a cathode gas into the cathode 10 of the stack 1.

In the start-up operation, the number of mole of the oxygen introduced into the cathode 10 per unit time is represented as MsO (mole/sec). On the other hand, in the normal operation, the number of mole of the oxygen introduced into the cathode 10 per unit time is represented as MrO (mole/sec). MsO is an abbreviation for mole starting oxygen whereas Mro is an abbreviation for mole rating oxygen. “Starting” is an abbreviation for start-up operation and “rating” is an abbreviation for normal (rating) operation. VrH is an abbreviation for volume rating hydrogen. VrO is an abbreviation for volume rating oxygen.

In the start-up operation, a concentration level reduction controlling (controlling of oxygen concentration reduction at the cathode 10) is carried out. Accordingly, the number of mole MsO at the start-up operation is set to be smaller than that MrO at the normal operation. In other words, at the cathode 10, the oxygen concentration at the start-up operation is set to be smaller than that at the normal operation. For example, the ratio MsO/MrO is set to be between 0.0001 and 0.5, particularly, between 0.01 and 0.2 is indicated. Accordingly, the oxygen is gradually introduced into the cathode 10 at the start-up operation. According to the Nernst equation, the electrode potential at the cathode 10 is restrained at the start-up operation to restrain a sudden rise of the electrode potential at the cathode.

Here, in the normal operation, the air (as a cathode gas) flow rate introduced into the cathode 10 of the stack 1 per unit time is represented as VrO. The value of VrO is variable depending on the type of the stack 1, however, normally the value VrO is set to be 140 l/sec. In the normal operation, the hydrogen gas (as an anode gas) flow rate introduced into the anode 11 of the stack 1 per unit time is represented as VrH. The value of VrH is variable depending on the type of the stack 1, however, normally the value VrH is set to be 0.029 l/sec.

According to the embodiment of this invention, flow rate VsH of anode gas introduced into the anode 11 of the stack 1 per unit time at the start-up operation is set to be the same with the flow rate VrH of anode gas introduced into the anode 11 of the stack 1 per unit time at the normal operation (VsH is nearly equal to VrH). The air flow rate of the oxygen introduced into the cathode 10 of the stack 1 of the fuel cell at the start-up operation is represented as VsO (l/sec.).

As an order of introduction of anode gas and cathode gas, it is preferable to first introduce the anode gas before the cathode gas. However, both gases may be introduced at the same time. Or, the cathode gas is introduced first before the anode gas. It is noted here that the VsH is an abbreviation for volume starting hydrogen and VsO for volume starting oxygen.

According to the embodiment of the invention, as mentioned earlier, the number of mole MsO is controlled to be reduced at the start-up operation. In other words, the air flow rate VsO introduced per unit time at the start-up operation is set to be smaller than the air flow rate VrO introduced per unit time at the normal operation. In this case, the air flow rate introduced into the cathode 10 per unit time at the start-up operation can be reduced by setting the rotation speed of the feeder source 22 per unit time lower than the rotation speed thereof at the normal operation using the control device 9.

As a result, the number of mole MsO (mole/sec) at the start-up operation is set to be smaller than the number of mole MrO at the normal operation. In other words, the oxygen concentration in the cathode 10 at the start-up operation is set to be lower than the oxygen concentration in the cathode 10 at the normal operation. This can restrain a sudden rise of the electrode potential at the cathode 10 at the start-up operation. This may restrain the deterioration of the cathode 10. Thus, even when the fuel cell system is used for a longer time, the deterioration (oxidization deterioration) of the cathode composing materials (for example, carbon system conductive material or catalyst) can be restrained.

The rise speed of electrode potential at the cathode 10 can be set to be equal to or lower than 30 mv/sec., and preferably, set to be 20 mv/sec. or less. Although the starting performance drops to some extent, considering the restrain of deterioration, the rise speed may be preferably set to be 10 mv/sec. or less, 5 mv/sec. or less. 2 mv/sec. or 1 mv/sec. or less also may be allowable. It is preferable to control the flow rate of air (cathode gas) introduced into the cathode 10 to be reduced, so that the rise speed of the electrode potential at the cathode 10 can be set to the speed mentioned above.

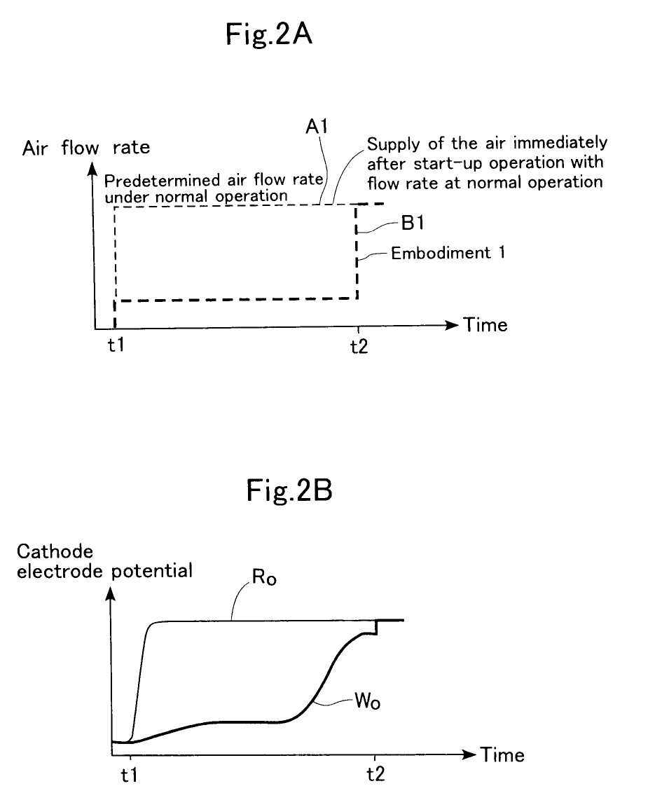

FIG. 2A schematically shows a relationship between the time and the introduced air flow rate at the start-up operation (between time t1 and time t2). In FIG. 2A, the performance line A1 associated with a comparative example and the line A1 indicates a performance line showing a supply of the air immediately after the start-up operation with a flow rate which is the same flow rate of the air as at the normal operation. The performance line B1 indicates a control line showing the air flow rate according to the embodiment 1 of the present invention. After the time t2 elapsed, the operation moves to the normal operation (for example, a rating operation). In FIG. 2B, a relationship between the time and the electrode potential at the cathode 10 in the start-up operation is schematically shown. In FIG. 2B, the performance line Ro associated with a comparative example and shows a relationship between the time and the electrode potential at the cathode 10 when the air is supplied in the normal operation from immediately after the start-up operation (without concentration level reduction controlling). The performance line Wo indicates a relationship between the time and the electrode potential at the cathode according to the embodiment 1 of the invention. As shown in FIG. 2A, since the concentration level reduction controlling is carried out at the start-up operation according to the embodiment 1, the electrode potential at the cathode 10 is gradually rising as is indicated with the line Wo in FIG. 2A and as is different from the performance line Ro, the sudden rising of the electrode potential at the cathode 10 can be avoided.

According to the embodiment of the invention, the start-up operation is carried out under an open circuit voltage state that the cathode 10 and the anode 11 of the stack 1 are electrically disconnected via the exterior load 17 and the electric discharge resistance, i.e., under a non-loaded state. The main switching element 16 disposed between the cathode 10 and the anode 11 is under OFF state at the start-up operation. Accordingly, no electric current flows through the cathode 10 and the anode 11 of the stack 1 and progress of an electric generation reaction at both cathode 10 and anode 11 is suppressed. Accordingly, a heat generated by the electric generation reaction at the start-up operation in the stack 1 is restrained. This can restrain the deterioration derived from the heat generation to eventually avoid an unnecessary consumption of fuel at the anode 11 upon start-up operation and at the same time deterioration to be caused by heat generation can be suppressed.

In the start-up operation, the hydrogen gas supplied to the anode 11 shall be preferably set to be more (under a meaning of the theoretical chemical amount) than the oxygen which causes an electro-chemical reaction for electric generation. The reason why the hydrogen is supplied more than the oxygen is explained as follows: The electro-chemical oxidization deterioration of the anode 11 can be restrained by securing sufficient electro-chemical oxidization of hydrogen at the anode 11 when the operation of the stack 1 is changed from the start-up operation to the normal operation. Particularly, the oxidization deterioration of the anode composing materials (such as carbon system conductive material, catalyst) can be restrained. If the hydrogen is deficient at the anode 11 when the operation moves from the start-up to normal operation, the anode composing materials may be oxidized.

According to the embodiment of the invention, the flow rate VsH of the anode gas introduced into the anode 11 at the start-up operation is set to be approximately the same flow rate VrH at the normal operation (VsH is nearly equal to VrH), however, this equation can be changed. In other words, the flow rate VsH of the anode gas at the start-up operation can be variably adjusted within a range between 30 and 100% of the flow rate VrH or the ratio VsH/VrH being within the range between 0.3 and 1.0. Further, according to the embodiment of the invention, the number of mole MsO (mole/sec) at the start-up operation being set to be constant, however, the number MsO can be increased with a stepwise manner or continuously with time elapses.

### Embodiment 2

In this embodiment 2, the structure, the function and effects are basically the same with the previous embodiment 1 and the drawing (FIG. 1) is commonly used in this embodiment 2. First, upon operating the stack 1 of the fuel cell, stack 1 is activated to carry out the start-up operation. The start-up operation is carried out under an open circuit voltage state that the cathode 10 and the anode 11 of the stack 1 are electrically disconnected via the exterior load 17 and the electric discharge resistance, i.e., under a non-loaded state. Thereafter, the stack 1 of the fuel cell starts normal operation. Under the start-up operation, the hydrogen gas, as an anode gas, is consecutively introduced into the anode 11 of the stack 1. The flow rate VsH of the anode gas introduced into the anode 11 per unit time at the start-up operation is set to be approximately the same flow rate VrH at the normal (for example, rated) operation (VsH is nearly equal to VrH).

Similarly, at the start-up operation, the air, as a cathode gas, is consecutively introduced into the cathode 10. In the start-up operation, the number of mole of the oxygen introduced into the cathode 10 per unit time is represented as MsO (mole/sec). On the other hand, in the normal operation, the number of mole of the oxygen introduced into the cathode 10 per unit time is represented as MrO (mole/sec).

In the start-up operation according to the embodiment of the invention, the concentration level reduction controlling is carried out. Accordingly, the number of mole MsO at the start-up operation is set to be smaller than that MrO at the normal operation. In other words, at the cathode 10, the oxygen concentration at the start-up operation is set to be smaller than that at the normal operation. A sudden rise of the electrode potential at the cathode 10 is restrained at the start-up operation. It is preferable to set the rise speed of the electrode potential at the cathode to 30 mv/sec or less under the concentration level increase controlling.

In more detail, under the start-up operation, the oxygen concentration of the cathode gas introduced into the cathode 10 of the stack 1 of the fuel cell is represented as CsO which stands for “Concentration starting Oxygen”, whereas the oxygen concentration of the cathode gas introduced into the cathode 10 of the stack 1 of the fuel cell at the normal operation is represented as CrO which stands for “Concentration rating Oxygen”.

As explained above, according to the embodiment of the invention, in the start-up operation, a concentration level reduction controlling is carried out. In other words, the concentration of oxygen CsO at the start-up operation is set to be smaller than that CrO at the normal operation (CsO<CrO) to keep the electrode potential at the cathode 10 to be low so that a sudden rise of the electrode potential at the cathode can be avoided. As a result, the deterioration of the cathode 10 is restrained.

In the start-up operation, the hydrogen gas supplied to the anode 11 shall be preferably set to be more under a meaning of the theoretical chemical amount than the oxygen which causes an electro-chemical reaction for electric generation. In this case, the hydrogen deficiency at the anode 11 can be avoided when the system moves from the start-up to normal operation to eventually suppress the oxidization deterioration of the anode composing materials (carbon material, catalyst, etc.) can be restrained.

It is preferable to set the ratio of MsO/MrO to be between 0.0001 and 0.5, particularly, between 0.01 and 0.2. This ratio can be applied to the ratio of CsO/CrO. According to the embodiment of this invention, flow rate VsH of anode gas introduced into the anode 11 of the stack 1 per unit time at the start-up operation is set to be approximately the same with the flow rate VrH of anode gas introduced into the anode 11 of the stack 1 per unit time at the normal operation (VsH is nearly equal to VrH). However, the flow rate VsH of the anode gas at the start-up operation can be variably adjusted within a range between 30 and 100% of the flow rate VrH or the ratio VsH/VrH being within the range between 0.3 and 1.0. Further, according to the embodiment of the invention, the start-up operation can be carried out under an electrical connection state between the cathode 10 and anode 11 through a conductive wire.

### Embodiment 3

According to this embodiment, the structure, functions and effects are basically the same with the embodiment 1, and therefore, the drawing FIG. 1 is commonly used with the embodiment 3. First, upon operating the stack 1 of the fuel cell, stack 1 is activated to carryout the start-up operation. The start-up operation is carried out under an open circuit voltage state that the cathode 10 and the anode 11 of the stack 1 are electrically disconnected via the exterior load 17 and the electric discharge resistance, i.e., under a non-loaded state. Thereafter, the stack 1 of the fuel cell starts normal operation. However, the start-up operation can be carried out under the cathode 10 and the anode 11 being electrically connected via a conductive wire. The opening degree of the cathode gas valve 20 can be stepwise or consecutively adjustable. In the start-up operation, the anode gas valve 50 is consecutively opened to consecutively introduce hydrogen gas into the anode 11 of the stack 1 and at the same time, the opening degree of the cathode gas valve 20 is increased stepwise to gradually increase the flow rate of the air introduced into the cathode 10.

Flow rate VsH of anode gas introduced into the anode 11 of the stack 1 per unit time at the start-up operation at the start-up operation is set to be approximately the same with the flow rate VrH of anode gas introduced into the anode 11 of the stack 1 per unit time at the normal operation (VsH is nearly equal to VrH). The number of oxygen mole per unit time introduced into the cathode 10 at the start-up operation is represented as MsO (mole/sec), whereas the number of oxygen mole per unit time introduced into the cathode 10 at the normal operation is represented as MrO. According to the embodiment of the invention, at the start-up operation, the air to be introduced into the cathode 10 is stepwise increased from MsO₁ (mole/sec), MsO₂ (mole/sec), MsO₃ (mole/sec), . . . (MsO₁<MsO₂<MsO₃). Here the number of each mole (MsO₁ to MsO₃) is set to be smaller than the number of mole MrO at the normal operation (MsO₁, MsO₂, MsO₃<MrO). In other words, the oxygen concentration at the cathode 10 is set to be smaller at the start-up operation than at the normal operation. Thus, the electrode potential at the cathode 10 in start-up operation can be restrained to be relatively small to suppress the rise speed of the electrode potential at the cathode 10.

According to the embodiment of this invention, flow rate VsH of anode gas introduced into the anode 11 per unit time at the start-up operation is set to be approximately the same with the flow rate VrH of anode gas introduced at the normal operation (VsH is nearly equal to VrH), but not limited to this flow relationship between the VsH and VrH. The flow rate VsH at the start-up operation can be variably adjusted within a range between 30 and 100% of the flow rate VrH or the ratio VsH/VrH being within the range between 0.3 and 1.0. It is preferable to supply more (under the meaning of theoretical chemical amount) hydrogen gas supplied to the anode 11 than the oxygen which causes an electro-chemical reaction for electric generation.

### Embodiment 4

According to this embodiment, the structure, functions and effects are basically the same with the embodiment 1, and therefore, the drawing FIG. 1 is commonly used with the embodiment 1. In the start-up operation, the anode gas valve 50 and the anode off gas valve 60 are opened and the hydrogen gas, as an anode gas, is consecutively introduced into the anode 11 of the stack 1 of the fuel cell. In the normal operation, under the cathode off gas valve being opened, a set of opening and closing operation of the cathode gas valve 20 is repeated for a predetermined time period thereby to discharge the air as a cathode gas intermittently with a predetermined time period. Here, assuming that the opening time period of the cathode gas valve 20 being t5 and that the closing time period of the cathode gas valve 20 being t6, by adjusting the ratio t5/t6, the number of oxygen mole introduced into the cathode 10 per unit time can be adjusted. In the start-up operation, this set of opening and closing operation is alternately repeated with the opening time t5 and closing time t6. In this case, if the start-up operation and the normal operation have the same rotation speed per unit time of the feeder source 22, due to the intermittent opening of the cathode gas valve 20, the concentration level reduction control at the cathode 10 can be carried out.

In the start-up operation, the number of mole of the oxygen introduced into the cathode 10 per unit time is represented as MsO (mole/sec). On the other hand, in the normal operation, the number of mole of the oxygen introduced into the cathode 10 per unit time is represented as MrO (mole/sec).

According to the embodiment of the invention, the start-up operation is carried out under an open circuit voltage state that the cathode 10 and the anode 11 of the stack 1 are electrically disconnected via the exterior load 17 and the electric discharge resistance, i.e., under a non-loaded state. In this embodiment, in order to intermittently open the cathode gas valve 20 at the start-up operation, in other words, to alternatively and repeatedly open and close the valve 20, the air is intermittently introduced into the cathode. Thus the concentration level reduction control is carried out. At the cathode 10, the number of oxygen mole MsO at the start-up operation is set to be smaller than that MrO at the normal operation (MsO<MrO). In other words, at the cathode 10, the oxygen concentration at the start-up operation is set to be smaller than that at the normal operation. Therefore, the sudden rise of the electrode potential at the cathode 10 can be suppressed.

According to the embodiment, flow rate VsH of anode gas introduced into the anode 11 per unit time at the start-up operation is set to be approximately the same with the flow rate VrH of anode gas introduced at the normal operation (VsH is nearly equal to VrH), but not limited to this flow relationship between the VsH and VrH. The flow rate VsH at the start-up operation can be variably adjusted within a range between 30 and 100% of the flow rate VrH. It is preferable to supply more (under the meaning of theoretical chemical amount) hydrogen gas supplied to the anode 11 than the oxygen which causes an electro-chemical reaction for electric generation. In this case, the hydrogen deficiency at the anode 11 can be avoided when the system moves from the start-up to normal operation. According to the embodiment, the start-up operation can be carried out under the cathode 10 and the anode 11 being electrically connected through the conductive wire.

### Embodiment 5

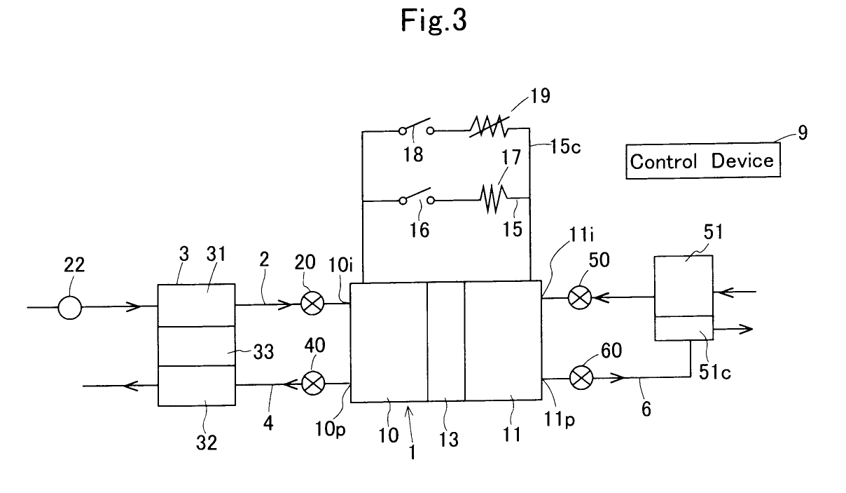

FIG. 3 shows an embodiment 5. According to this embodiment, the structure, functions and effects are basically the same with the embodiment 1. As shown in FIG. 3, at the start-up operation, the cathode 10 and the anode 11 of the stack 1 are electrically connected through the lead wires 15c and 15. In the lead wire 15c, a switching element 18 and a variable electric discharge resistance 19 are provided. The switching element 18 switches over the variable electric discharge resistance 19 to be OFF or ON. The variable electric discharge resistance 19 is provided electrically in parallel with the exterior load 17. The control device 9 controls each valve 20, 40, 50 and 60, the feeder source 22, the main switching element 16 and the switching element 18.

At the start-up operation, the hydrogen gas is consecutively introduced into the anode 11 of the stack 1 of the fuel cell and at the same time the air is consecutively introduced into the cathode 10. In this start-up operation, the concentration level reduction control is carried out. In the start-up operation, the number of mole of the oxygen introduced into the cathode 10 per unit time is represented as MsO (mole/sec). On the other hand, in the normal operation, the number of mole of the oxygen introduced into the cathode 10 per unit time is represented as MrO (mole/sec). The number of mole MsO (mole/sec) at the start-up operation is set to be smaller than the number of mole MrO at the normal operation. In other words, the oxygen concentration in the cathode 10 at the start-up operation is set to be lower than the oxygen concentration at the normal operation. This can restrain a rising of the electrode potential at the cathode 10 at the start-up operation. The ratio MsO/MrO is preferably set to be between 0.0001 and 0.5, and particularly, between 0.01 and 0.2 is preferable.

Further, according to the embodiment of the invention, at the early stage of the start-up operation, the switching element 18 is set to be ON under the condition that the switching element 16 is set to be OFF and that the exterior load 17 is not electrically connected between the cathode 10 and the anode 11. A resistance increase controlling is carried out by the control device 9 to gradually increase the electric resistance value of the variable electric discharge resistance 19 as the time elapses from the initial stage of the start-up operation. When the electric resistance value of the variable electric discharge resistance 19 is small, the electric current flowing through the lead wire 15c and the variable electric discharge resistance 19 is high and the cell voltage is low. On the other hand, when the electric resistance value of the variable electric discharge resistance 19 is large, the electric current flowing through the lead wire 15c and the variable electric discharge resistance 19 is low and the cell voltage is high.

According to the embodiment of the invention, at the start-up operation, in addition to the concentration level reduction control, the resistance increase control is carried out. In other words, the control device 9, under the switching element 18 being ON at the startup operation, controls to gradually increase the electric resistance value of the variable electric discharge resistance 19 as the time elapses. Then, the cell voltage is low at the initial stage of the start-up operation. However, as the time lapses, the cell voltage gradually becomes high. In other words, at the initial stage of the start-up operation, the electrode potential at the cathode 10 is suppressed and indicates a low value. However, as the time elapses, or as the start-up operation moves towards the final stage, the electrode potential at the cathode 10 gradually becomes high. This can further restrain a sudden rising speed of the electrode potential of the cathode 10 of the fuel cell and further, the sudden rising of the electrode potential of the cathode 10 of the fuel cell. As the result, the deterioration of the cathode 10 is further restrained. According to this embodiment, the resistance value of the variable electric discharge resistance 19 can be variable and accordingly, the rising speed of the electrode potential of the cathode 10 according to the type of stack 1, etc., also can be variably controlled. According to the embodiment of the invention, the concentration level reduction control and the resistance increase control are carried out substantially at the same time. However, it may be possible to carry out the concentration level reduction control, keeping the resistance value to be substantially constant.

According to the embodiment of the invention, the flow rate VsH of the anode gas introduced into the anode 11 at the start-up operation is set to be approximately the same flow rate VrH at the normal operation (VsH is nearly equal to VrH), but is not limited to this balance. In other words, the flow rate VsH of the anode gas at the start-up operation can be variably adjusted within a range between 30 and 100% of the flow rate VrH or the ratio VsH/VrH being within the range between 0.3 and 1.0. In the start-up operation, the hydrogen gas supplied to the anode 11 shall be preferably set to be more under the meaning of the theoretical chemical amount than the oxygen which causes an electro-chemical reaction for electric generation.

### Embodiment 6

According to this embodiment, the structure, functions and effects are basically the same with the embodiment 1, and therefore, the drawing FIG. 1 is commonly used with the embodiment 1. At the start-up operation, the hydrogen is not introduced into the anode 11 of the stack 1 of the fuel cell, but nitrogen gas is introduced. Under the condition, the opening degree of the cathode gas valve 20 is stepwise or consecutively increased to gradually increase the air flow rate into the cathode 10. At the start-up operation, the number of mole of the oxygen introduced into the cathode 10 per unit time is represented as MsO (mole/sec). On the other hand, in the normal operation, the number of mole of the oxygen introduced into the cathode 10 per unit time is represented as MrO (mole/sec).

According to the embodiment, at the start-up operation, the air flow rate into the cathode is stepwise increased from MsO₁ (mole/sec), MsO₂ (mole/sec), MsO₃ (mole/sec), . . . (MsO₁<MsO₂<MsO3). Here the number of each mole (MsO₁ to MsO₃) is set to be smaller than the number of mole MrO at the normal operation (MsO₁, MsO₂, MsO₃<MrO). In other words, the oxygen concentration at the cathode 10 is set to be smaller at the start-up operation than at the normal operation. Thus, the electrode potential at the cathode 10 in start-up operation can be restrained to be relatively small to suppress the rise speed of the electrode potential at the cathode 10. The rise speed of the electrode potential at the cathode can be set to 30 mv/sec or less.

According to the embodiment of the invention, flow rate VsH of anode gas introduced into the anode 11 per unit time at the start-up operation is set to be approximately the same with the flow rate VrH of anode gas introduced at the normal operation (VsH is nearly equal to VrH), but not limited to this flow rate relationship. The flow rate VsH at the start-up operation can be variably adjusted within a range between 30 and 100% of the flow rate VrH or the ratio VsH/VrH being within the range between 0.3 and 1.0. It is preferable to supply more (under the meaning of theoretical chemical amount) hydrogen gas supplied to the anode 11 than the oxygen which causes an electro-chemical reaction for electric generation by concentration level increase controlling.

### Example 1

An example 1 of the invention is explained hereinafter. The example 1 was executed based on the embodiment 1 and FIG. 1 is referred to for this example 1. The number of layered cell of stack 1 is 6 (six). The flow rate of hydrogen gas (anode gas) introduced into the anode 11 of the stack 1 per unit time under normal operation is indicated as VrH. In this example, the value of VrH was set to be VrH=1.766 l/min (approximately=29 ml/sec.). The flow rate of the air (cathode gas) introduced into the cathode 10 of the stack 1 per unit time under normal operation is indicated as VrO. In this example, the value of VrO was set to be VrO=8.4 l/min (approximately=140 ml/sec.)

According to this example, the flow rate of hydrogen gas VsH introduced into the anode 11 per unit time under start-up operation was set to be the same value with the flow rate of hydrogen VrH under the normal operation. Further, the flow rate of the air VsO introduced into the cathode 10 of the stack 1 was set to be 12% of the total flow rate of the air VrO under the normal operation. The value VsO was 1 l/min (approximately=16.7 ml/sec.). Under the start-up operation, the hydrogen gas (flow rate: approximately VsH=VrH) was introduced into the anode 11 and the air (flow rate: VrO×12%, approximately 1 l/min (approximately=16.7 ml/sec.) was introduced into the cathode 10 through mass flow.

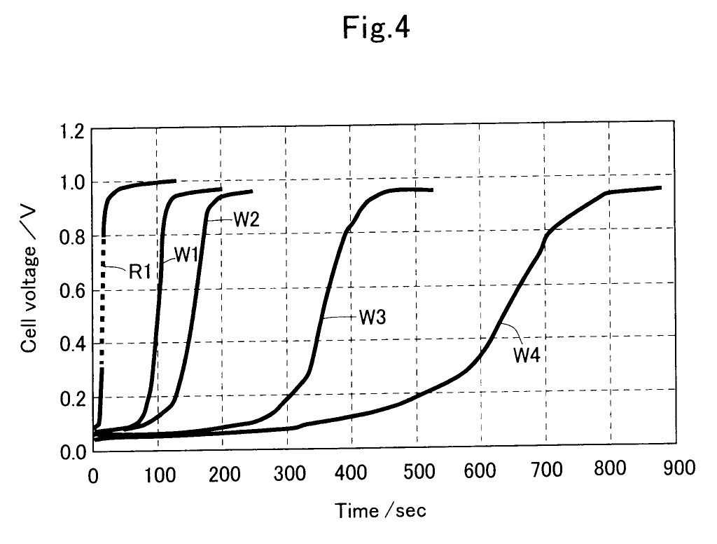

In this case, it took 115.7 seconds for the electrode potential at the cathode 10 to reach 0.9 volt. In this case, the rising speed of the electrode potential at the cathode 10 was 0.9 volt/115.7 sec. (This is equal to approximately 7.78 mv/sec.). According to this example 1, since the rising speed of the electrode potential at the cathode 10 is slow and even the stack 1 is used for a long period of time, the oxidization deterioration of the carbon system conductive material (carbon black, for example) composing the catalyst layers for the cathode 10 and the anode 11 and the catalyst can be suppressed. Accordingly, it may be said to be preferable to set the rising speed of the electrode potential at the cathode 10 to be equal to or less than 10 mv/sec. The performance line W1 in FIG. 4 indicates the rising speed of the electrode potential at the cathode 10 according to the example 1.

Similarly, the comparative example was experimented. As a comparative example, the stack 1 used in the example 1 was used and as similar to the example 1, the flow rate of hydrogen gas VsH introduced into the anode 11 per unit time under start-up operation was set to be the same value with the flow rate of hydrogen VrH under the normal operation (VsH nearly equals to VrH). Further the nitrogen gas was encapsulated into the cathode 10 in advance. Under such condition, at the start-up operation, the hydrogen gas was introduced into the anode and at the same time the air was introduced into the cathode 10 (the same flow rate with the air flow rate VrO introduced under normal operation: 8.4 l/min., approximately equals to 140 ml/sec.) The hydrogen gas per unit time (flow rate: approximately VsH=VrH) was introduced into the anode 11. In this comparative example, it took 17.6 seconds for electrode potential at the cathode 10 to reach 0.9 volt. In this case, the rising speed of the electrode potential at the cathode 10 was 0.9 volt/17.6 sec. (This is equal to approximately 51 mv/sec.). The rising speed of the electrode potential at the cathode 10 was very fast. The performance line R1 in FIG. 4 indicates the rising speed of the electrode potential at the cathode 10 according to the comparative example.

According to the comparative example, since the rising speed of the electrode potential at the cathode 10 is very fast and when the stack 1 is used for a long period of time, the oxidization deterioration of the carbon system conductive material composing the catalyst layers for the cathode 10 may progress. As the carbon system conductive material, a carbon system carrier (carbon black) which supports the catalyst can be used. According to the example and the comparative example, the test conditions were as follows: the cell temperature was 70° C., the dew point at the anode 11 was 54° C. and the dew point of the cathode gas was 58° C.

(Relationship between the rising speed of cathode electrode potential and the cathode deterioration) The inventors of this application tested the relationship between the rising speed of cathode electrode potential and the cathode deterioration. According to the results of the test, we confirmed the finding that the concentration of CO₂ included in the cathode off gas discharged from the cathode 10 is few when the rising speed of the electrode potential at the cathode 10 is slow. (Not known at the time of application).

According to the test, single cell was used, flow rate of 5 l/min. hydrogen gas was introduced into the anode as an anode gas, and at the same time flow rate of 8 l/min. nitrogen gas was introduced into the cathode. The cell temperature was 70° C., the dew point at the anode side was 54° C. and the dew point of the cathode side was 58° C. The cathode electrode potential was forcibly controlled by a potentio-stat which was electrically connected to the single cell until the cell voltage reaches from zero to 0.9 volt. After the cell voltage reached 0.9 volt, the cell was exposed for 20 minutes and then measured the concentration of CO₂ included in the cathode off gas discharged from the cathode by a measurement device (Horiba make VIA-510: non-dispersive infrared absorption all purpose gas analyzer). Table 1 indicates the measurement result of CO₂ concentration included in the cathode off gas. The CO₂ volume at the rising speed 20 mv/sec. of electrode potential was 0.062 ml. The CO₂ volume at the rising speed 50 mv/sec. of electrode potential was 0.095 ml, and the CO₂ volume at the rising speed 100 mv/sec. of electrode potential was 0.167 ml. Thus, the CO₂ concentration increases when the electrode potential speed increases. We infer the reason that the oxidization of the carbon system catalyst carrier (carbon black) included in the cathode progressed to become the CO₂.

TABLE 1

| Rising speed at the electrode | Concentration of carbon |
|---|---|
| potential (mv/sec.) | dioxide (ml) |
| 20 | 0.062 |
| 50 | 0.095 |
| 100 | 0.167 |

### Example 2

The example 2 according to the invention will be described hereinafter. The example 2 is based on the structure of embodiment 1 and uses FIG. 1 for explanation. The same stack was used as the stack 1 of the example 1. According to this example, the flow rate of hydrogen gas VsH introduced into the anode 11 per unit time under start-up operation was set to be the same value with the flow rate of hydrogen VrH under the normal operation. (VsH nearly equals to VrH). Further, the flow rate of the air VsO introduced into the cathode 10 per unit time was set to be 6% of the flow rate of the air VrO under the normal operation. The value VsO was 0.5 l/min (approximately=8.3 ml/sec).

Under the start-up operation, the hydrogen gas per unit time was introduced into the anode 11 and the air was introduced into the cathode. It took 172.9 seconds for the electrode potential at the cathode 10 to reach 0.9 volt. In this case, the rising speed of the electrode potential at the cathode 10 was 0.9 volt/172.9 sec. (This is equal to approximately 5.2 mv/sec). The performance line W2 in FIG. 4 indicates the rising speed of the electrode potential at the cathode 10 according to the example 2. According to this example 1, since the rising speed of the electrode potential at the cathode 10 is rather slow and the oxidization deterioration of the carbon system conductive material composing the catalyst layers for the cathode 10 can be suppressed. Accordingly, it is preferable to set the rising speed of the electrode potential at the cathode 10 to be equal to or less than 7 mv/sec.

### Example 3

The example 3 according to the invention will be described hereinafter. The example 3 is based on the structure of embodiment 1 and uses FIG. 1 for explanation. The same stack was used as the stack 1 of the example 1. According to this example, the flow rate of hydrogen gas VsH introduced into the anode 11 per unit time under start-up operation was set to be the same value with the flow rate of hydrogen VrH under the normal operation. (VsH nearly equals to VrH). Further, the flow rate of the air VsO introduced into the cathode 10 per unit time was set to be 2.9% of the flow rate of the air VrO under the normal operation. The value VsO was 0.24 l/min (approximately=4 ml/sec.).

Under the start-up operation, the hydrogen gas per unit time was introduced into the anode 11 of the stack 1 and the air per unit time was introduced into the cathode 10 of the stack 1. It took 416.8 seconds for the electrode potential at the cathode 10 to reach 0.9 volt. In this case, the rising speed of the electrode potential at the cathode 10 was 0.9 volt/416.8 sec. (This is equal to approximately 2.1 mv/sec). The performance line W3 in FIG. 4 indicates the rising speed of the electrode potential at the cathode 10 according to the example 3. According to this example 1, since the rising speed of the electrode potential at the cathode 10 is rather slow and the oxidization deterioration of the carbon system conductive material composing the catalyst layers for the cathode 10 can be suppressed. Accordingly, it is preferable to set the rising speed of the electrode potential at the cathode 10 to be equal to or less than 3 mv/sec.

### Example 4

The example 4 according to the invention will be described hereinafter. The example 4 is based on the structure of embodiment 1 and uses FIG. 1 for explanation. The same stack was used as the stack 1 of the example 1. According to this example, the flow rate of hydrogen gas VsH introduced into the anode 11 of the stack 1 per unit time under start-up operation was set to be the same value with the flow rate of hydrogen VrH under the normal operation. (VsH nearly equals to VrH). Further, the flow rate of the air VsO introduced into the cathode 10 per unit time was set to be 1.4% of the flow rate of the air VrO under the normal operation. The value VsO was 0.12 l/min (approximately=2 ml/sec.). Under the start-up operation, the hydrogen gas per unit time was introduced into the anode 11 and the air per unit time was introduced into the cathode 10. It took 761.9 seconds for the electrode potential at the cathode 10 to reach 0.9 volt. In this case, the rising speed of the electrode potential at the cathode 10 was 0.9 volt/761.9 sec. (This is equal to approximately 1.2 mv/sec). The performance line W4 in FIG. 4 indicates the rising speed of the electrode potential at the cathode 10 according to the example 4. According to this example, since the rising speed of the electrode potential at the cathode 10 is slow and the oxidization deterioration of the carbon system conductive material composing the catalyst layers for the cathode 10 can be suppressed. Accordingly, it is preferable to set the rising speed of the electrode potential at the cathode 10 to be equal to or less than 2 mv/sec.

### Example 5

An example of manufacturing a film electrode assembly forming the stack explained above will be explained. This is just an example and the conditions referred here do not limit the invention and may be changeable according to the necessary circumstances.

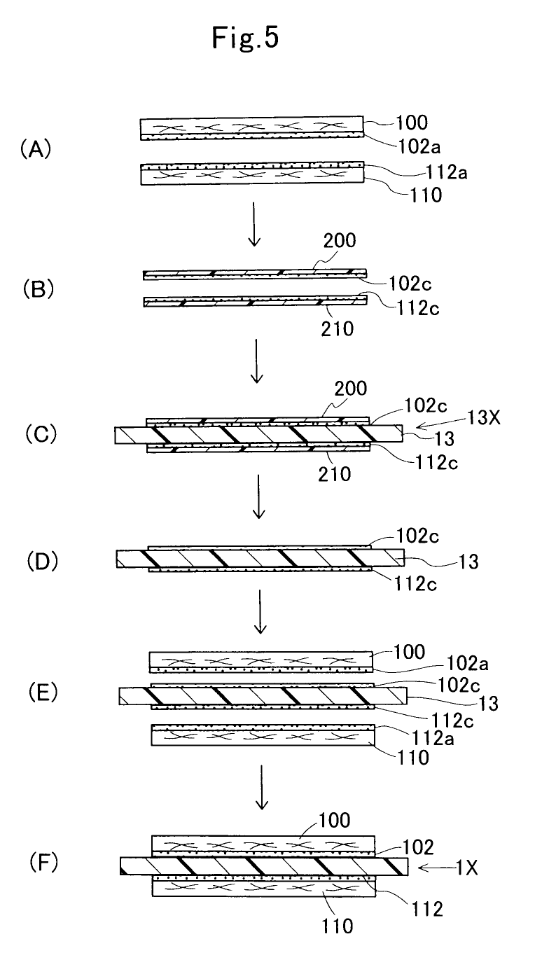

First, as shown in FIG. 5(A), a cathode gas diffusion layer 100 and an anode gas diffusion layer 110 are made by a carbon fiber integrated body. The conditions for making the cathode gas diffusion layer 100 and the anode gas diffusion layer 110 are as follows: water 100 g, acetylene black (granular conductive material) 300 g and carbon fiber as vapor-grown carbon fiber (VGCF, conductive fiber) 50 g are mixed to obtain a mixed liquid. The mixed liquid was agitated by an agitator for 10 minutes. Further, the mixed liquid was mixed with 125 g Deparsion solution (Du Pont Mitsui Fluoro-chemical make: 60 weight % PTFE included) including fluorine resin (PTFE) as water repellent. This mixed liquid was further agitated for 10 minutes to form a carbon paste including the water repellent. The carbon paste including water repellent was applied on and coated on one surface of a carbon paper in a thickness direction by doctor-blade method (GDL, Torayka TGP-H060, thickness of 200 micro-m, Toray make). The thickness was 4.5 mmg/cm2. After that the coated carbon paste was exposed for 10 minutes under the room temperature so that the water repellent included carbon paste was permeated into the carbon paper in the thickness direction with respect to the carbon paper. Then extra water included in the paper was dried (for 30 minutes under 80° C.). After that the carbon paper was held for 60 minutes under the sintering temperature of 350° C. and sintered the PTFE (water repellent) impregnated in the carbon paper. Thus the cathode gas diffusion layer 100 and the anode gas diffusion layer 110 (refer to FIG. 5(A)) were made.

Next, the platinum carried carbon carrying platinum of 55 weight % was used (Tanaka Klkinzoku make: TEC10E60E). The platinum carrying carbon is a carbon minute carrying platinum as a catalyst (electric conductive material; granular electric conductive material). The platinum carrying carbon 12 g, ion-exchange resin solution of 5 weight % 127 g (Asahi Kasei make: SS-1080), water 23 g and alcohol as a mold auxiliary agent (isopropyl alcohol) 23 g were sufficiently mixed and a catalyst paste for cathode was formed thereby. The ion-exchange resin solution has an ion-conductive (proton-conductive) carbonized fluorine system electrolyte polymer as a main component and formed by dissolving or dispersing the electrolyte polymer into the mixed solution of water and ethanol as a liquid media. The carbonized fluorine system electrolyte polymer has a perfluorosulfonic acid as a main component. The catalyst paste for cathode was coated on a surface of the cathode gas diffusion layer 100 by the doctor blade method to form the catalyst layer 102a for cathode. (Refer to FIG. 5(A)).

As a catalyst for anode, instead of using the platinum carrying carbon, platinum ruthenium mixed metal alloy (Tanaka Kikinzoku, TEC61E54) was used. This is a minute body (electric conductive minute substance) of carbon carrying the platinum and the ruthenium. The platinum ruthenium carbon has a platinum carrying concentration of 20 to 40 weight % and ruthenium carrying concentration of 15 to 30 weight %. And, by using the platinum ruthenium alloy carrying carbon, as similar to the method described above, the catalyst paste for anode was formed. The catalyst paste for anode was coated on the surface of the anode gas diffusion layer 110 by the doctor blade method and the catalyst layer 112a for anode was layered (Refer to FIG. 5 (B)).

After the processes were finished, the catalyst paste for cathode was coated on a Teflon sheet 200 by the doctor blade method and the catalyst layer 102c for cathode was layered (Refer to FIG. 5 (B)). The above mentioned catalyst paste for anode was coated on a Teflon sheet 210 by the doctor blade method and the catalyst layer 112c for anode was layered (Refer to FIG. 5 (B))

As shown in FIG. 5(C), ion-conductive polymer type electrolyte film 13 (Du Pont make: Nafion 111 (trade name) thickness of 25 micrometer) was used. The catalyst layer 112c for anode was placed on one surface of the electrolyte film 13 and the catalyst layer 102c for cathode was placed on the other surface of the electrolyte film 13 and a layered product 13X was formed. (FIG. 5(C)). Next, thus formed layered product 13X was hot-pressed in a thickness direction by using a hot-press mold and preliminary hot-pressed and joined together. In this case, the hot press conditions were: temperature of 100 to 130° C., pressure of 5 to 10 MPa and the time for 5 to 2 minutes. Thereafter, the Teflon sheets 200 and 210 were peeled off. (FIG. 5 (D).

As shown in FIG. 5 (E), the cathode gas diffusion layer 100 was placed on the catalyst layer 102c for cathode and the anode gas diffusion layer 110 was placed on the catalyst layer 112c for anode. Then, under the hot press condition (temperature of 100 to 160° C., pressure of 6 to 10 MPa and the time for 1 to 5 minutes), the layers 100 and 110 were hot-pressed using a hot-press mold and the film electrode assembly 1X was formed. At this time, the catalyst layers 102a and 102c were layered and become the catalyst layer 102 for cathode. The catalyst layers 112a and 112c were layered and become the catalyst layer 112 for anode. According to the manufacturing method explained above, the catalyst layers 102c for cathode and catalyst layer 112c for anode were layered on both surfaces of the electrolyte film 13. However, the catalyst layer 102c for cathode and the catalyst layer 112c for anode at the electrolyte film 13 side can be abolished.

(The others) The humidifier 3 has the humidifying portion 31 and humidity absorbing portion 32 integrally formed with the humidifying portion. However, the structure is not limited to this and the humidifying portion 31 to which water is supplied and the humidity absorbing portion 32 can be separately formed. Or, in cases, the humidifier 3 can be abolished. The number of cell to be stacked on the stack 1 is not particularly limited to a particular number and for example, 2 to 1000 cells can be exampled. The exterior load 17 is shown as a type driven by direct current electricity; however, it may be a type driven by alternate current electricity inverted from direct current electricity generated at the stack 1 by inverter. In additions, the invention which is intended to be protected is not to be construed as limited to the particular embodiments and examples disclosed. Further, the embodiments and examples described herein are to be regarded as illustrative rather than restrictive. Variations and changes may be made by others, and equivalents employed, without departing from the subject matter of the present invention.

### Usage Possible Industry

The invention can be used for example, fuel cell system for stationary use, vehicle use, electric machine use, electronic device use or portable use.

1. An operation method for a fuel cell under a normal operation after a start-up operation for activating the fuel cell, by using the fuel cell having a cathode to which a cathode fluid including oxygen is supplied, an anode to which an anode fluid including hydrogen is supplied and an electrolyte film provided between and supported by the cathode and the anode, characterized in that in a state where the cathode and the anode of the fuel cell are in open circuit voltage state under the start-up operation, a concentration level reduction controlling to restrain a rise of electrode potential at the cathode is conducted by lowering an oxygen concentration level at a cathode side of the fuel cell to a level lower than an oxygen concentration level under the normal operation.

2. An operation method for a fuel cell according to claim 1, wherein after the concentration level controlling is conducted under the start-up operation, oxygen concentration increase controlling is conducted in which a concentration level of oxygen introduced into the cathode increases as the time from a start of the start-up operation elapses.

3. An operation method for a fuel cell according to claim 1, wherein under the concentration level reduction controlling, the number of mole MsO (mole/sec) is set to be smaller than the number of mole MrO (mole/sec), wherein the number of mole MsO is defined as the oxygen introduced per unit time into the cathode under the start-up operation, whereas the number of MrO is defined as the oxygen introduced per unit time into the cathode under the normal operation.

4. An operation method for a fuel cell according to claim 3, wherein the ratio MsO/MrO is set to be between 0.0001 and 0.5.

5. An operation method for a fuel cell according to claim 1, wherein a cathode fluid passage connected to the cathode of the fuel cell and a cathode fluid valve provided in the cathode fluid passage are provided, an opening degree of the cathode fluid valve is variable between 0 and 100%, and wherein the concentration level reduction controlling is conducted by setting the opening degree of the cathode fluid valve to an intermediate position between 0 and 100%.

6. An operation method for a fuel cell according to claim 1, wherein a cathode fluid passage connected to the cathode of the fuel cell and a cathode fluid valve provided in the cathode fluid passage are provided, and wherein the concentration level reduction controlling is conducted by alternately repeating a time in which the cathode fluid valve is closed and a time in which the cathode fluid valve is opened.

7. An operation method for a fuel cell according to claim 1, the concentration level reduction controlling is conducted under the anode fluid being introduced into the anode of the fuel cell or during the anode fluid being introduced into the anode of the fuel cell.

8. An operation method for a fuel cell according to claim 1, wherein a flow rate of the anode fluid is defined by VsH/VrH=0.3 to 1.0, wherein VsH represents a flow rate of the anode fluid introduced into the anode of the fuel cell per unit time under the start-up operation and VrH represents a flow rate of the anode fluid introduced into the anode of the fuel cell per unit time under the normal operation.

9. An operation method for a fuel cell according to claim 1, wherein under the concentration level increase controlling, a rise speed of the electrode potential at the cathode is set to be 30 mv/sec or less.

10. (canceled)

11. (canceled)

12. (canceled)

13. (canceled)

14. (canceled)

15. (canceled)

16. (canceled)

17. (canceled)

18. (canceled)

19. (canceled)

20. An operation method for a fuel cell having a cathode to which a cathode fluid including oxygen is supplied, an anode to which an anode fluid including hydrogen and an electrolyte film provided between and supported by the cathode and the anode, under a normal operation after a start-up

21. operation for activating the fuel cell, wherein a concentration level reduction controlling is conducted to restrain a rise of electrode potential at the cathode by lowering the concentration level of oxygen introduced into the cathode of the fuel cell per unit time under the start-up operation under a condition that a variable electric discharge resistance which can variably change an electric resistance value is kept to be electrically connected between the cathode and the anode of the fuel cell than the concentration level of oxygen introduced into the cathode of the fuel cell per unit time under the normal operation.

22. An operation method for a fuel cell according to claim 20, wherein at the same time the concentration level reduction controlling is conducted, a resistance level increase controlling is conducted in which the electric resistance value of the variable electric discharge resistance is gradually increased.

23. An operation method for a fuel cell according to claim 20, wherein after the concentration level reduction controlling is conducted under the start-up operation, oxygen concentration increase controlling is conducted in which a concentration level of oxygen introduced into the cathode increases as the time from a start of the start-up operation elapses.

24. An operation method for a fuel cell according to claim 20, wherein under the concentration level reduction controlling, the number of mole MsO (mole/sec) is set to be smaller than the number of mole MrO (mole/sec), wherein the number of mole MsO is defined as the oxygen introduced per unit time into the cathode under the start-up operation, whereas the number of MrO is defined as the oxygen introduced per unit time into the cathode under the normal operation.

25. An operation method for a fuel cell according to claim 20, wherein the ratio MsO/MrO is set to be between 0.0001 and 0.5.

26. An operation method for a fuel cell according to claim 20, the concentration level reduction controlling is conducted under the anode fluid being introduced into the anode of the fuel cell or during the anode fluid being introduced into the anode of the fuel cell.

27. An operation method for a fuel cell according to claim 20, wherein a flow rate of the anode fluid is defined by VsH/VrH=0.3 to 1.0, wherein VsH represents a flow rate of the anode fluid introduced into the anode of the fuel cell per unit time under the start-up operation and VrH represents a flow

28. rate of the anode fluid introduced into the anode of the fuel cell per unit time under the normal operation.

29. An operation method for a fuel cell according to claim 20, wherein under the concentration level increase controlling, a rise speed of the electrode potential at the cathode is set to be 30 mv/sec or less.

30. An operation method for a fuel cell according to claim 20, wherein a variable electric discharge resistance is disposed in electrically parallel with an exterior load which is electrically connected between the cathode and the anode of the fuel cell and is switched ON/OFF by a switching element.
